(19) United States
(12) Patent Application Publication
(10) Pub. No.: US 2013/0022706 A1
(43) Pub. Date: Jan. 24, 2013

(54) Animal Feed Additive

(71) Applicant: J. Kent Bamford, Haxtun, CO (US)

(72) Inventor: J. Kent Bamford, Haxtun, CO (US)

(73) Assignee: INCO DIGESTIVE, LLC, Haxtun, CO (US)

(21) Appl. No.: 13/187,443

(22) Filed: Jul. 20, 2011

(51) Int. Cl. A23K 1/16; A23K 1/18

(52) U.S. Cl. 426/2; 426/74; 426/648

(57) ABSTRACT

The invention provides feed additive compositions for supplementing the diet of an animal that can reduce the odor of manure produced by animals consuming the compositions. The invention also relates to methods for manufacturing the compositions and methods of using the compositions as animal feed additives.

### TECHNICAL FIELD

The invention relates to compositions comprising feed additives that can reduce the odor of manure produced by animals consuming the compositions. The invention also relates to methods for manufacturing the compositions and methods of using the compositions as animal feed additives.

### BACKGROUND OF INVENTION

The U.S. has developed a very efficient and sophisticated system for producing meat, milk, poultry, and egg products involving concentrated animal feeding operations (CAFOs) in order to insure the sustainability of America's food supply. CAFOs, including dairies and cattle feedlots, and the associated animal waste management systems produce emissions of odor, odorants, and odorous gases, such as ammonia, H₂S. For instance, in the United States during a normal 150 day finishing period, each animal excretes about 900 kg of collectible manure, or about 1,800 kg/hd of manure per head of feedlot capacity per year. Cattle feedlots in the U.S. produce an estimated 18 million metric tons/yr of collectable manure containing at least 360,000 metric tons/yr of total nitrogen and 135,000 metric tons/yr of total phosphorus.

Historically, air quality associated with CAFOs has received minimal consideration. The sources of odor emissions from CAFOs may include production facilities (open lot and confinement buildings; manure/wastewater storage and/or treatment systems) ponds, pits, lagoons, stockpiles, composting operations; and land application systems for solid or liquid manure, treated effluent, or open lot runoff.

Many technologies for control of odor and odorants from CAFOs have been utilized that generally fall under four approaches including (1) ration manipulation, (2) improved manure collection and treatment, (3) capture and treatment of odorous gases, and (4) enhanced dispersion.

Reducing the protein content in the manure has been attempted in order to reduce manure odor. Additionally, various feeding strategies, including reduced nitrogen intake, phase feeding, repartitioning agents, improved animal genetics, and various feed additives have been used. Some of the feed additives include: sugar beet pulp, soybean hulls, Jerusalem artichoke, zeolite, and yucca extracts.

Manure treatment methods include odor control measures, such as maintaining aerobic conditions during storage, aerobic treatment (aerated lagoons or composting), anaerobic digestion or biochemical treatment.

The capture-and-treatment methods include the use of covered storage pits or lagoons, soil incorporation of applied liquid or solid manure, and dry scrubbers for building exhaust gases, including soil absorption beds, bio-filter fields, or packed beds. Soils and organic materials such as peat or wood chips, have been used as they readily absorb odorous gases and provide for aerobic decomposition of captured odorants.

As the location size grows and the proximity of CAFOs to urban areas decreases, odor control becomes an increasingly urgent concern, and therefore additional options for reducing or eliminating animal odors associated with CAFOs are needed. Such options are provided by the compositions and methods of this invention. Additionally, the compositions and method of this invention achieve other advantages discussed more fully below.

### SUMMARY OF INVENTION

The present invention provides feed additives based on compositions containing plant extracts, zeolites and minerals, and methods of producing and using the compositions to reduce or eliminate odors associated with CAFOs and processing, storing and using animal manure as a fertilizer. The feed additives of the invention include a plant extract combined with a mineral clay, and a metal or trace mineral. In some embodiments, the metal or trace mineral is one of cobalt or iron or both. In specific embodiments, the mineral is supplied as one of cobalt sulfate and ferrous sulfate. In specific embodiments, the plant extract of the feed additives is an extract of Yucca plants or Agave plants or both. In specific embodiments, the mineral clay is a zeolite and in certain embodiments, the mineral clay is an aluminum silicate. In specific embodiments, the mineral clay is aluminum calcium silicate or hydrated sodium calcium aluminum silicate, or both.

One embodiment is a feed additive composition containing about 15% to about 40%, by weight, of Yucca schidigera extract, about 45% to about 80% by weight, of alumina calcium silicate, about 0.1% to about 0.75%, by weight, of hydrated sodium calcium alumina silicate; about 0.1% to about 0.75%, by weight, of cobalt sulfate; and about 0.1% to about 0.75%, by weight, of ferrous sulfate.

In one embodiment, the animal feed additive composition includes about 35%, by weight, of Yucca schidigera extract, about 64%, by weight, of alumina calcium silicate, about 0.5%, by weight, of hydrated sodium calcium alumina silicate; about 0.25%, by weight, of cobalt sulfate, and about 0.25%, by weight, of ferrous sulfate.

Another aspect of the invention is a method of supplementing the diet of an animal by feeding a composition including a plant extract, a mineral clay, and a mineral selected from at least one of cobalt and iron, to the animal. In some embodiments, the animal feed composition is fed directly to the animal. In other embodiments the animal feed additive is first mixed with a feed, which mixture is fed to the animal. In some embodiments, the plant extract in the composition fed to the animal contains an extract of Yucca or Agave plants. In some embodiments, the plant extract in the composition fed to the animal contains a zeolite. In some embodiments, the plant extract in the composition fed to the animal contains an aluminum silicate. In some embodiments, the plant extract in the composition fed to the animal contains cobalt or iron. In a specific embodiment, the composition is fed to a bovine animal. In a specific embodiment, the composition is fed to cattle.

Another aspect of the invention is a method of making an animal feed additive by mixing a plant extract with a mineral clay and a mineral selected from cobalt and iron. In preferred embodiments, the plant extract used to mix the animal feed additive is Yucca schidigera extract. In some embodiments, a zeolite is used to mix the animal feed additive.

This Summary of the Invention is neither intended nor should be construed as being representative of the full extent and scope of the present invention. Moreover, references made herein to “the present invention,” or aspects thereof, should be understood to mean certain embodiments of the present invention and should not necessarily be construed as limiting all embodiments to a particular description. The present invention is set forth in various levels of detail in the Summary of the Invention as well as in the attached drawings and the Description of Embodiments and no limitation as to the scope of the present invention is intended by either the inclusion or non-inclusion of elements, components, etc. in this Summary of the Invention. Additional aspects of the present invention will become more readily apparent from the Description of Embodiments, particularly when taken together with the drawings.

### DESCRIPTION OF EMBODIMENTS The present invention is drawn to compositions that supplement the feed of animals and reduce the odor associated with the animal and the animal's excrement. The invention provides methods for manufacturing the compositions as well as methods for using the compositions as animal feed additives. The use of the compositions of the invention can lower the cost and regulatory burden of maintaining a CAFO where manure is generated, disposed, stored and/or processed to be used as a fertilizer.

While the following terms are believed to have well-defined meanings in the art, the following are set forth to define the terms as used herein, and facilitate explanation of the invention.

As used herein, the term “feed” broadly refers to any kind of material, liquid or solid, that is used for nourishing an animal, and for sustaining normal or accelerated growth of an animal including newborns and young developing animals. Preferably, the feed is cattle feed.

The term “animal” as used herein refers to animals typically kept in farms, animal operations, CAFOs, zoos, and includes bovine, fowl, porcine, ovine, and equine species. By way of example, the methods and compositions of the invention can be used for the treatment of cattle, poultry (chickens, turkeys, ducks, quail, geese) pigs, goats and sheep. In a specific embodiment, the methods and compositions of the invention can be used for the treatment of ruminants.

As used herein, reducing the odor of animal waste products or manure refers to a process that results in a lower concentration of one or more malodorous compounds in animal waste products. Odorous compounds, such as but not limited to hydrogen sulfide, ammonia, indole, skatole (i.e, 3-methyl-1H-indole), p-cresol, and organic acids, are known to contribute to the malodorous quality of manure. The concentration of such malodorous compounds in manure or in a sample of air in contact with the manure can be determined by any method well known in the art, including, but not limited to, gas chromatography and mass spectroscopy.

### Animal Feed Additive Compositions

The compositions of the invention comprise plant extracts. In specific embodiments, the plant extracts in the compositions are chosen for their ability to reduce the odor of wastes produced by animals. Saponins, present in certain plants, are surfactants having both lipophilic and hydrophilic portions that provide both fat-soluble and water-soluble moieties in the same molecule. The lipophilic region may be a steroid, triterpene, or alkaloid, and is termed a sapogenin. The hydrophilic portion of the molecule contains one or more water-soluble carbohydrate side chains. The structural complexity of saponins is derived largely from the carbohydrate portion of the molecule due to the many different types of possible side chain carbohydrates, such as glucose, xylose, galactose, pentose or methylpentose, which may have different connectivity and/or anomeric configuration. Saponins purportedly have antiprotozoal activity attributable to the saponin's ability to interact with cholesterol in protozoal cell membranes and cause cell lysis. Plant extracts useful in the compositions and methods of the present invention preferably include saponins derived from the plant source. As such, plant sources useful in preparation of the compositions of the present invention include plants of the family: Lillaecae, genus: Yucca, such as Yucca schidigera, and the family: Amaryllidaccae, genus: Agave. Additional sources of useful plant extracts and may be included in the compositions of the present invention include extracts of soybeans, fenugreek, peas, tea, yams, sugar beets, alfalfa, asparagus, aloe, vanilla, zhimu, Sapindus saponaria, citrus fruits (limonoid saponins) as well as from Quillaja saponaria bark. Such extracts, and either liquid or powder form, can be prepared from any of the foregoing plant sources by techniques well-known to those skilled in the art. Additionally, extracts from each of these plants sources are commercially available. For example, Yucca extracts can be derived by extracting yucca powder with an aqueous solution that may or may not contain some fraction of an organic solvent, such as methanol, ethanol, propanol, butanol, or the like. Commercially available Yucca extracts typically have total solids content usually in the range from 5-50%. The saponin content of a typical 50% solids by weight yucca extract is usually in the range of about 1-2% saponins by weight as measured by HPLC analysis.

In a specific embodiment, the composition of the invention includes at least one plant extract containing at least 0.1% by weight saponins as measured by HPLC.

In a related embodiment, the composition of the invention includes at least one plant extract from one or both of Yucca and/or Agave plants. In a specific embodiment, the composition of the invention includes an extract of Yucca. In a related embodiment, the composition of the invention includes an extract of Yucca schidigera. In these embodiments, the composition may contain between 0.1% and 80%, by weight, of an extract of Yucca schidigera. In these embodiments, the composition may contain between 5% and 50%, by weight, of an extract of Yucca schidigera. In these embodiments, the composition may contain between 15% and 40%, by weight, of an extract of Yucca schidigera. In a specific embodiment, the composition may contain about 35%, by weight, of an extract of Yucca schidigera.

In addition to a plant extract, the compositions of the invention contain mineral clays (aluminosilicates) including, but not limited to, montmorillonite clay, bentonite and one or more zeolites. When present, the mineral clay product is a standard commercial grade (examples include, but are not limited to, montmorillonite clay, bentonite and zeolite). Extractions and productions of diatomaceous earth and mineral clays are known in the art and may be obtained from a variety of commercial sources. Examples include hydrated magnesium and/or aluminum silicates, such as sepiolite and other clay minerals of the sepiolite-palygorskite-family as well as zeolites, such as klinoptilolite, and certain silicates, such as, but not limited to aluminum calcium silicate, or hydrated sodium calcium aluminum silicate. These mineral clays can adsorb and absorb substances including toxins or odiferous chemicals in the gastrointestinal tract of an animal.

In a specific embodiment, the composition of the invention includes at least one mineral clay. In related embodiments, the composition of the invention includes a zeolite. In specific embodiments, compositions of the invention include at least one of aluminum calcium silicate, or hydrated sodium calcium aluminum silicate.

In embodiments in which aluminum calcium silicate is present, the composition may contain between 10% and 90%, by weight, of aluminum calcium silicate. In these embodiments, the composition may contain between 25% and 80%, by weight, of aluminum calcium silicate. In these embodiments, the composition may contain between 45% and 80%, by weight, of aluminum calcium silicate. In a specific embodiment, the composition may contain about 64%, by weight, of aluminum calcium silicate.

In embodiments in which hydrated sodium calcium aluminum silicate is present, the composition may contain between 0.1% and 20%, by weight, of hydrated sodium calcium aluminum silicate. In these embodiments, the composition may contain between 0.2% and 5%, by weight, of hydrated sodium calcium aluminum silicate. In these embodiments, the composition may contain between 0.3% and 1%, by weight, of hydrated sodium calcium aluminum silicate. In a specific embodiment, the composition may contain about 0.5%, by weight, of hydrated sodium calcium aluminum silicate.

In addition to a plant extract, the compositions of the invention contain minerals or metals that supplement or further increase the efficacy of the compositions of the invention. In some embodiments, a variety of suitable trace minerals are included in the compositions of the invention. In some embodiments, the organic trace minerals may include metal chelates comprising metal ions and an amino acid ligand. Alternatively, the organic trace mineral may be present in the compositions of the invention as a metal salt. The metal ions may include zinc ions, copper ions, manganese ions, iron ions, chromium ions, cobalt ions, magnesium ions, calcium ions, and combinations thereof. In specific embodiments, the metal ions are iron, manganese, and/or copper ions. Metals may act as sulfide binding agents that can react with sulfide ions and form insoluble or poorly soluble reaction products. In this manner, sulfide binding agents can react with sulfide ions to form a precipitate product that cannot be absorbed well by the host animal, thereby preventing dietary sulfur from causing adverse effects. As a specific example, iron (II) chloride reacts with sulfide ion forming iron sulfide, which is poorly soluble and therefore drops out of solution. Because compositions of the invention are to be administered to animals, the sulfide binding agent should be substantially non-toxic. In addition, the sulfide binding agent should be selected so that any reaction products that may form in the process of binding sulfide ion are also substantially non-toxic.

In a specific embodiment, a mineral additive to the composition of the invention includes a source of cobalt. When present in the compositions of the present invention, the cobalt may be provided as cobalt acetate, cobalt carbonate, cobalt chloride, cobalt oxide, cobalt sulfate or combinations thereof. In one embodiment, the composition of the invention includes cobalt sulfate. In embodiments in which cobalt sulfate is present, the composition may contain between 0.1% and 20%, by weight, of cobalt sulfate. In these embodiments, the composition may contain between 0.1% and 5%, by weight, of cobalt sulfate. In these embodiments, the composition may contain between 0.2% and 1%, by weight, of cobalt sulfate. In a specific embodiment, the composition may contain about 0.25%, by weight, of cobalt sulfate.

In a specific embodiment, a mineral additive to the composition of the invention includes a source of iron. When present in the compositions of the present invention, the iron may be provided as ferrous fumarate, iron ammonium citrate, iron carbonate iron, chloride iron, gluconate iron, iron phosphate, iron pyrophosphate, iron sulfate, iron magnesium acetate, ferric hypophosphite, ferric albuminate, ferric chloride, ferric citrate, ferric oxide saccharate, ferric ammonium citrate, ferrous chloride, ferrous gluconate, ferrous iodide, ferrous sulfate, ferrous lactate, ferrous fumarate, heme, ferric trisglycinate, ferrous bisglycinate, ferrous asparto glycinate, ferric nitrate, ferrous hydroxide saccharate, ferric sulfate, ferric gluconate, ferric aspartate, ferrous sulfate heptahydrate, ferrous phosphate, ferric ascorbate, ferrous formate, ferrous acetate, ferrous malate, ferrous glutamate, ferrous cholinisocitrate, ferroglycine sulfate, ferric oxide hydrate, ferric pyrophosphate soluble, ferric hydroxide saccharate, ferric manganese saccharate, ferric subsulfate, ferric ammonium sulfate, ferrous ammonium sulfate, ferric sesquichloride, ferric choline citrate, ferric manganese citrate, ferric quinine citrate, ferric sodium citrate, ferric sodium edetate, ferric formate, ferric ammonium oxalate, ferric potassium oxalate, ferric sodium oxalate, ferric peptonate, ferric manganese peptonate, or combinations thereof. In one embodiment, the composition of the invention includes ferrous sulfate. In embodiments in which ferrous sulfate is present, the composition may contain between 0.1% and 20%, by weight, of ferrous sulfate. In these embodiments, the composition may contain between 0.1% and 5%, by weight, of ferrous sulfate. In these embodiments, the composition may contain between 0.2% and 1%, by weight, of ferrous sulfate. In a specific embodiment, the composition may contain about 0.25%, by weight, of ferrous sulfate.

In one embodiment, the feed additive compositions of the invention include a plant extract, a mineral clay, and a metal selected from at least one of cobalt and iron. In another embodiment, the feed additive compositions of the invention include a plant extract, a mineral clay, and a metal selected from cobalt and iron. In another embodiment, the feed additive compositions of the invention include a plant extract selected from a yucca extract and an agave extract, a mineral clay, and a trace mineral. In another embodiment, the feed additive compositions of the invention include an extract of yucca, a mineral clay, and a metal selected from cobalt and iron. In another embodiment, the feed additive compositions of the invention include an extract of agave, a mineral clay, and a metal selected from cobalt and iron. In another embodiment, the feed additive compositions of the invention include an extract of yucca, a zeolite, and a metal selected from cobalt and iron. In another embodiment, the feed additive compositions of the invention include an extract of yucca, an aluminum silicate, and a metal selected from cobalt and iron. In another embodiment, the feed additive compositions of the invention include an extract of yucca, an aluminum silicate, and a metal selected from cobalt and iron. In each of these embodiments, a preferred plant extract is a yucca extract.

In each of these embodiments, a preferred mineral clay is one or both of aluminum calcium silicate, and hydrated sodium calcium aluminum silicate.

In each of these embodiments, a preferred metal is one or both of colbalt and iron.

In each of these embodiments, a particularly preferred plant extract is Yucca schidigera. In each of these embodiments, a particularly preferred mineral clay is both aluminum calcium silicate and hydrated sodium calcium aluminum silicate.

In each of these embodiments, a particularly preferred metal is both cobalt sulfate and ferrous sulfate.

In a specific embodiment, the animal feed additive composition comprises about 15% to about 40%, by weight, of a Yucca schidigera extract, about 45% to about 80% by weight, of alumina calcium silicate, about 0.1% to about 0.75%, by weight, of hydrated sodium calcium alumina silicate; about 0.1% to about 0.75%, by weight, of cobalt sulfate; and about 0.1% to about 0.75%, by weight, of ferrous sulfate. In a related embodiment, the animal feed additive composition comprises about 35%, by weight, of a Yucca schidigera extract, about 64%, by weight, of alumina calcium silicate, about 0.5%, by weight, of hydrated sodium calcium alumina silicate; about 0.25%, by weight, of cobalt sulfate; and about 0.25%, by weight, of ferrous sulfate.

### Animal Feed Methods and Materials

In one embodiment, the invention includes a method of processing animal feed including contacting an animal feed material with at least one of the compositions of the invention. By adding the composition to the animal feed, the components of the composition will reach the rumen of a feed animal along with the consumed feed. In one embodiment, the sulfur content of an animal feed is tested and if the animal feed material turns out to have a relatively high sulfur content, a composition of the invention can be added to the animal feed.

The animal feed materials, to which compositions of the invention can be added, may include many different components such as, but not limited to, alfalfa hay, alfalfa haylage, almond hulls, apple components, rolled barley, barley malt sprouts, barley silage, bermuda grass, blood meal, bluegrass, brome, canary grass, canola seed, canola meal, chocolate byproduct, dried citrus pulp, clover, sudangrass hay, dry-rolled corn, tempered-rolled corn, steam-flaked corn, ground shelled corn, cracked corn, hominy feed, corn gluten feed, corn silage, wet brewer's grain, dry brewer's grain, distillers grains (dried and wet), stillage, soybean meal, soybean seeds, soybean hulls, sunflower meal, sunflower oil, sunflower seeds, tomato products, wheat bran, rolled wheat, wheat hay, wheat middlings, wheat silage, whey, fescue, fish byproducts, hay, legumes, linseed, meat meal, meat and bone meal, rolled oats, oat hay, oat silage, orchard grass, peanut meal, potato byproduct meal, rice bran, rye, safflower, dry rolled sorghum, steam-flaked sorghum, sorghum silage, soybean hulls, whole cottonseed, cottonseed hulls, cottonseed meal, sugar beet pulp, dehydrated beet pulp, bakery waste, cottonseed meal, yellow grease, white grease, vegetable oil, tallow, water, hydrolyzed feather meal, cane molasses, sugar beat molasses, and the like, and combinations thereof.

In another embodiment, compositions of the invention can be fed directly to an animal. In another embodiment, the compositions are added to an animal feed that is fed to an animal. Any methods and appliances may be used to mix the compositions of the invention with an animal feed. In one embodiment, a composition of the invention is added directly to the feed just prior to feeding the animal. The compositions may be applied to and/or mixed with an animal feed by any mechanized means, which may be automated.

The amount of the animal feed compositions of the invention feed to an animal depends in part on the feeding regimen and the type of feed, and can be determined empirically. For example, the useful ratio of a composition to animal feed typically ranges from 0.1% to 1% by dry weight, preferably, 0.3 to 0.8%, and most preferably at about 0.5%. For cattle, the compositions of the invention are typically fed at the rate of about one-half to two grams per head, per day, when mixed in a complete feed ration. The compositions of the invention can also be used in conjunction, or in rotation with other types of deodorants and nutrient supplements.

Manufacture of the Compositions of the Invention The present invention further provides a method for manufacturing compositions of the invention. To produce the compositions of the invention, a stock solution or powder of a plant extract is mixed with one or more mineral clay(s), and one or more minerals or metals. The individual ingredients may be mixed in any order to achieve a homogenous mixture for use as a feed or feed additive. The resulting dry compositions are preferably stored at a temperature between about 5° C. and about 40° C. If the composition is formulated as a liquid, it is preferably stored at a temperature between about 10° C. and about 30° C., and if not used immediately, dried for storage within 24 hours. The dried compositions are stored at room temperature and the dried compositions may be screened in a separator so that particles of a preferred size are selected. The dried compositions can be sent to a bulk bag filler for packing.

The foregoing description of the present invention has been presented for purposes of illustration and description. Furthermore, the description is not intended to limit the invention to the form disclosed herein. Consequently, variations and modifications commensurate with the above teachings, and the skill or knowledge of the relevant art, are within the scope of the present invention. The embodiments described hereinabove are further intended to explain the best mode known for practicing the invention and to enable others skilled in the art to utilize the invention in such, or other, embodiments and with various modifications required by the particular applications or uses of the present invention. It is intended that the appended claims be construed to include alternative embodiments to the extent permitted by the prior art.

What is claimed is:

1. An animal feed additive comprising:
a plant extract,
a mineral clay,
and a mineral selected from at least one of cobalt and iron.

2. The animal feed additive of claim 1 wherein the plant extract is an extract of at least one of Yucca and Agave plants.

3. The animal feed additive of claim 1 wherein the mineral clay is a zeolite.

4. The animal feed additive of claim 1 wherein the mineral clay is an aluminum silicate.

5. The animal feed additive of claim 1 wherein the mineral clay is at least one of aluminum calcium silicate and hydrated sodium calcium aluminum silicate.

6. The animal feed additive of claim 1 wherein the mineral is both cobalt and iron.

7. The animal feed additive of claim 1 wherein the mineral is at least one of cobalt sulfate and ferrous sulfate.

8. The animal feed additive of claim 1 wherein the mineral is both cobalt sulfate and ferrous sulfate.

9. The animal feed additive of claim 1 comprising:
about 15% to about 40%, by weight, of Yucca schidigera extract,
about 45% to about 80% by weight, of alumina calcium silicate,
about 0.1% to about 0.75%, by weight, of hydrated sodium calcium alumina silicate;
about 0.1% to about 0.75%, by weight, of cobalt sulfate; and
about 0.1% to about 0.75%, by weight, of ferrous sulfate.

10. The animal feed additive of claim 1 comprising:
about 35%, by weight, of Yucca schidigera extract,
about 64%, by weight, of alumina calcium silicate,
about 0.5%, by weight, of hydrated sodium calcium alumina silicate;
about 0.25%, by weight, of cobalt sulfate; and
about 0.25%, by weight, of ferrous sulfate.

11. A method of supplementing the diet of an animal comprising: administering a composition comprising a plant extract, a mineral clay, and a mineral selected from at least one of cobalt and iron, to the animal

12. The method of claim 11, wherein the composition is mixed into an animal feed that is fed to the animal.

13. The method of claim 11, wherein the plant extract in the composition comprises an extract of at least one of Yucca and Agave plants.

14. The method of claim 11, wherein the mineral clay in the composition is a zeolite.

15. The method of claim 11, wherein the mineral clay in the composition is an aluminum silicate.

16. The method of claim 11, wherein the mineral in the composition is at least one of cobalt and iron.

17. The method of claim 11, wherein the animal is bovine.

18. A method of making an animal feed additive comprising: mixing a plant extract with a mineral clay and a mineral selected from at least one of cobalt and iron.

19. The method of claim 18, wherein the plant extract is Yucca schidigera extract.

20. The method of claim 18, wherein the mineral clay is a zeolite.
